(19) United States
(12) Patent Application Publication
(10) Pub. No.: US 2026/0341606 A1
(43) Pub. Date: Oct. 29, 2026

(54) Waterproof Box for Switch Outlet Combo

(71) Applicant: Zhejiang Yuchuang Electronic Technology Co., Ltd., Wenzhou (CN)

(72) Inventors: Yangen CHEN, Wenzhou (CN); Jingzheng CHEN, Wenzhou (CN)

(21) Appl. No.: 19/415,469

(22) Filed: Dec. 10, 2025

(30) Foreign Application Priority Data
Apr. 24, 2025 (CN) 202520784895.6

(51) Int. Cl. H01H 9/04

(52) U.S. Cl. CPC H01H 9/04

(57) ABSTRACT

A waterproof box for a switch outlet combo includes a base shell and a box cover, where the base shell and the box cover are pivotally connected through a hinge mechanism, an upper edge of the base shell is provided with at least two lower mounting members of the hinge mechanism, the lower mounting members are positioned on two mutually perpendicular upper edge sides, respectively, the box cover is selectively provided with an upper mounting member corresponding to at least one of the two lower mounting members according to the need, and the lower mounting member and the upper mounting member are assembled to form the hinge mechanism. The waterproof box for a switch outlet combo enables the box cover to be opened either horizontally or vertically by simply selecting different mounting positions in the lower mounting members. This design allows adaptation to diverse requirements.

### CROSS-REFERENCE TO RELATED APPLICATIONS

The present application claims priority to Chinese Patent Application No. 202520784895.6, filed Apr. 24, 2025, the entire disclosure of which is incorporated herein by reference.

### TECHNICAL FIELD

The present disclosure relates to a waterproof box for a switch outlet combo.

### BACKGROUND

Chinese Invention Patent Publication No. CN219833137U discloses a waterproof box for a switch outlet combo, including a front box and a rear box, where a front of the rear box is provided with an engaging opening; the front box includes a middle box panel and a front cover, and the front cover is connected to a top of the middle box panel such that the front cover is flippable upward by using connecting points as hinge points; the middle box panel is provided with an outlet panel, and a surface of the middle box panel facing the front cover is provided with a water retaining wall surrounding the outlet panel and extending toward an inner cavity of the front cover; an isolation groove recessed toward the rear box is formed between an outer edge of the surface of the middle box panel facing the front cover and the water retaining wall, and the inner walls of the left, right, and bottom sides of the front cover are provided with water retaining edges that extend toward a bottom of the isolation groove when the front cover is closed onto the middle box panel; a top of the water retaining wall is provided with two spaced water retaining ribs, with a distance therebetween being equal to or smaller than a connecting length of the hinge points between the front cover and the middle box panel. However, in this waterproof box, a hinge mechanism is disposed only on a longitudinal side, and the cover can be opened solely in a longitudinal direction. This design lacks flexibility to adapt to requirements for all cases, and the opening direction of the cover cannot be adjusted flexibly.

### SUMMARY

In view of the deficiency in the background, the technical solution to be solved by the present disclosure is to provide a waterproof box for a switch outlet combo, which enables a box cover to be opened in a set direction by selecting the position of a hinge mechanism of the box cover during installation.

To this end, the present disclosure is implemented by the following technical solution:
A waterproof box for a switch outlet combo includes a base shell and a box cover, where the base shell and the box cover are pivotally connected through a hinge mechanism, an upper edge of the base shell is provided with at least two lower mounting members of the hinge mechanism, the lower mounting members are positioned on two mutually perpendicular upper edge sides, respectively, the box cover is selectively provided with an upper mounting member corresponding to at least one of the two lower mounting members according to the need, and the lower mounting member and the upper mounting member are assembled to form the hinge mechanism.

Preferably, the hinge mechanism includes a lower sleeving portion, pivot pins, and an upper sleeving portion.

Preferably, the upper edge of the base shell is provided with two lower mounting members, and the box cover is provided with two upper mounting members corresponding to the lower mounting members.

Preferably, each of the lower sleeving portions is disposed on a side wall of the base shell, a center of the lower sleeving portion is provided with pivot pin holes, both ends of the pivot pins are exposed after the pivot pins are inserted into the pivot pin holes; and each of the upper sleeving portions is disposed on an outer side wall of the box cover, both ends of the upper sleeving portion extend downward to form ear plates, an inclined cover plate is formed between the ear plates, the ear plates are provided with sleeving holes, the ear plates are sleeved over both ends of the pivot pins through the sleeving holes, and the inclined cover plate encloses the lower sleeving portion.

Preferably, the lower mounting member includes the lower sleeving portion and the pivot pins inserted therethrough, and the upper mounting member independently includes the upper sleeving portion; or alternatively, the upper mounting member includes the upper sleeving portion and the pivot pins inserted therethrough, and the lower mounting member independently includes the lower sleeving portion.

Preferably, a side of the base shell is provided with a wire routing groove, both sides and a bottom of the wire routing groove are provided with insertion grooves, inserting plates are inserted into the insertion grooves, and the inserting plates are removable to allow external wire access when required.

Preferably, the pivot pins include a left pivot pin and a right pivot pin, an outer end of each of the left pivot pin and the right pivot pin is provided with a cap, an inner end of each of the left pivot pin and the right pivot pin is provided with an inserting end, and the inserting end is provided with a conical head and an annular groove behind the conical head; and the two ear plates are respectively located at both ends of the lower sleeving portion, the pivot pin holes and the sleeving holes of the ear plates are aligned, and the left pivot pin and the right pivot pin are inserted through the sleeving holes of the ear plates and the pivot pin holes from both sides respectively.

By adopting the above technical solutions, the present disclosure has the following beneficial effects: The waterproof box for a switch outlet combo enables the box cover to be opened either horizontally or vertically by simply selecting different mounting positions in the lower mounting members. This design allows adaptation to diverse requirements, such as spatial constraints where the waterproof box is installed, preferential exposure needs arising from component layout, or operational habits of different users. Therefore, the waterproof box for a switch outlet combo provided by the present disclosure enables the box cover to be opened in a set direction by selecting the position of the hinge mechanism of the box cover during installation.

### BRIEF DESCRIPTION OF THE DRAWINGS

The present disclosure has the following figures:

FIG. 1 is a structural view of a waterproof box for a switch outlet combo provided by the present disclosure.

FIG. 2 is a structural view of a base shell in FIG. 1.

FIG. 3 is a structural view of a box cover in FIG. 1.

### DETAILED DESCRIPTIONS OF THE EMBODIMENTS

To further elaborate on the technical means employed by the present disclosure to achieve the intended objectives and the resultant efficacy, the specific implementations, structures, features, and functions of the present disclosure will be described below in detail in combination with the drawings and preferred embodiments.

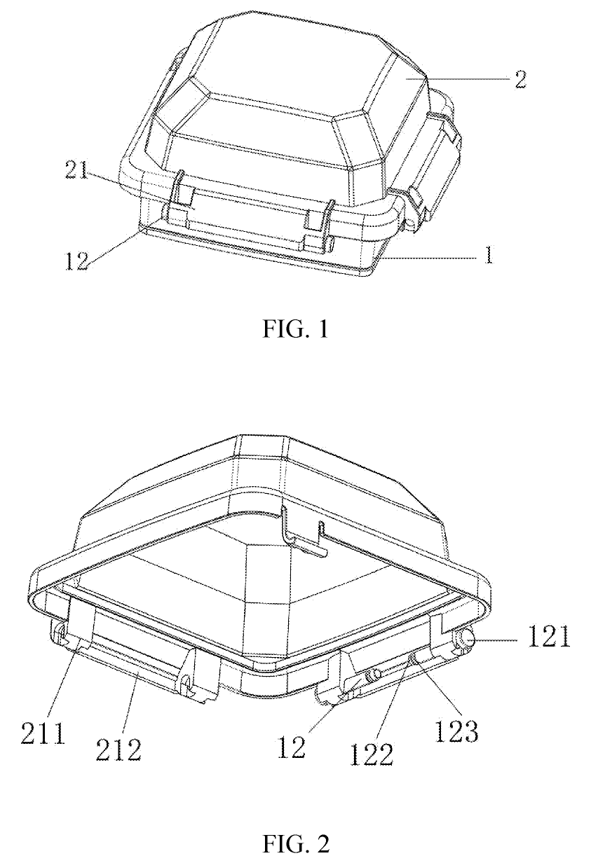

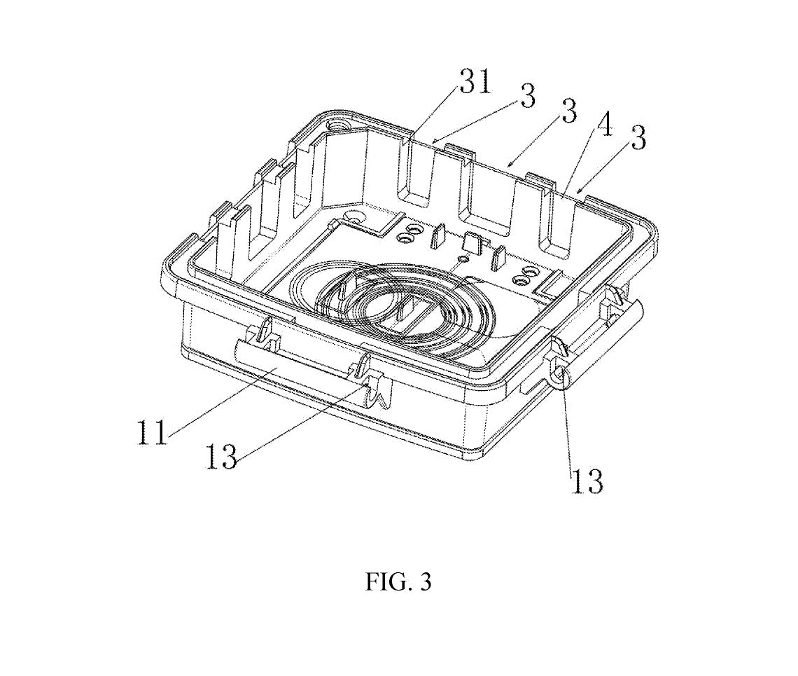

Referring to FIGS. 1-3, a waterproof box for a switch outlet combo provided by the present disclosure includes a base shell 1 and a box cover 2, where the base shell 1 and the box cover 2 are pivotally connected through a hinge mechanism, an upper edge of the base shell is provided with at least two lower mounting members of the hinge mechanism, the lower mounting members are positioned on two mutually perpendicular upper edge sides, respectively, the box cover is selectively provided with an upper mounting member corresponding to at least one of the two lower mounting members according to the need, and the lower mounting member and the upper mounting member are assembled to form the hinge mechanism. Preferably, the hinge mechanism includes a lower sleeving portion 11, pivot pins 12, and an upper sleeving portion 21. In this embodiment, the base shell 1 is provided with two lower mounting members, and the box cover 2 is provided with two upper mounting members corresponding to the lower mounting members. Connection of the hinge mechanism may be completed through selection and installation within the assembly of the waterproof box for a switch outlet combo, thereby enhancing flexibility and convenience during installation and matching.

Referring to FIGS. 1-3, the above hinge mechanism has the following detailed structure: each of the lower sleeving portions 11 is disposed on a side wall of the base shell 1, each of the upper sleeving portions 21 is disposed on an outer side wall of the box cover 2, and a center of the lower sleeving portion 11 is provided with pivot pin holes 13; the pivot pins 12 include a left pivot pin and a right pivot pin, an outer end of each of the left pivot pin and the right pivot pin is provided with a cap 121, an inner end of each of the left pivot pin and the right pivot pin is provided with an inserting end, and the inserting end is provided with a conical head 122 and an annular groove 123 behind the conical head 122; both ends of the upper sleeving portion 21 extend downward to form ear plates 211, an inclined cover plate 212 is formed between the ear plates, the ear plates 211 are provided with sleeving holes, the ear plates 211 are sleeved over both ends of the pivot pins 12 through the sleeving holes, and the inclined cover plate 212 encloses the lower sleeving portion 11; and the two ear plates 211 are respectively located at both ends of the lower sleeving portion 11, the pivot pin holes 13 and the sleeving holes of the ear plates 211 are aligned, and the left pivot pin and the right pivot pin are inserted through the sleeving holes of the ear plates 211 and the pivot pin holes 13 from both sides respectively. The hinge mechanism has the advantages of easy assembly and disassembly. Moreover, the upper sleeving portion 21 encloses the lower sleeving portion 11 from the left, right, and upper sides, such that the overall structure is more compact and beautiful. The side where the pivot pins are not installed particularly emphasizes compactness and beauty.

Referring to FIGS. 1-3, the optional combinations of the above upper mounting member and the above lower mounting member are as follows: the lower mounting member includes the lower sleeving portion 11 and the pivot pins 12 inserted therethrough, and the upper mounting member independently includes the upper sleeving portion 21; or alternatively, the upper mounting member includes the upper sleeving portion 21 and the pivot pins 12 inserted therethrough, and the lower mounting member independently includes the lower sleeving portion 11.

Referring to FIG. 1, to simultaneously achieve convenient wire routing and sealed enclosure, a side of the base shell is provided with a wire routing groove 3, both sides and a bottom of the wire routing groove 3 are provided with insertion grooves 31, inserting plates 4 are inserted into the insertion grooves 31, and the inserting plates 4 are removable to allow external wire access when required.

Referring to FIGS. 1-3, the waterproof box of Embodiment 1 of the present disclosure is used as follows:
1. Hinge connection is selected on different sides according to usage habits and installation space conditions.
2. During wiring, the inserting plate 4 is firstly pulled out upward and removed, and a wire is introduced through the wire routing groove 3 into the waterproof box for a switch outlet combo for connection.

Referring to FIG. 1, Embodiment 2 of the present disclosure is basically identical to Embodiment 1, with the only difference lying in arrangement of the upper mounting member in the hinge mechanism of the box cover 2. In this embodiment, the box cover 2 is provided with only one upper mounting member. There are two types of box covers 2: one type is configured with an upper mounting member solely on a front side, and the other type is configured with an upper mounting member solely on the left side or the right side. When the box cover 2 is selected, it is necessary to select one of the two types and install the box cover 2 onto the base shell 1 at the corresponding position.

1. A waterproof box for a switch outlet combo, comprising a base shell and a box cover, wherein the base shell and the box cover are pivotally connected through a hinge mechanism, an upper edge of the base shell is provided with at least two lower mounting members of the hinge mechanism, the lower mounting members are positioned on two mutually perpendicular upper edge sides, respectively, the box cover is selectively provided with an upper mounting member corresponding to at least one of the two lower mounting members according to the need, and the lower mounting member and the upper mounting member are assembled to form the hinge mechanism.

2. The waterproof box for a switch outlet combo according to claim 1, wherein the hinge mechanism comprises a lower sleeving portion, pivot pins, and an upper sleeving portion.

3. The waterproof box for a switch outlet combo according to claim 2, wherein the upper edge of the base shell is provided with two lower mounting members, and the box cover is provided with two upper mounting members corresponding to the lower mounting members.

4. The waterproof box for a switch outlet combo according to claim 3, wherein each of the lower sleeving portions is disposed on a side wall of the base shell, a center of the lower sleeving portion is provided with pivot pin holes, both ends of the pivot pins are exposed after the pivot pins are inserted into the pivot pin holes; and each of the upper sleeving portions is disposed on an outer side wall of the box cover, both ends of the upper sleeving portion extend downward to form ear plates, an inclined cover plate is formed between the ear plates, the ear plates are provided with sleeving holes, the ear plates are sleeved over both ends of the pivot pins through the sleeving holes, and the inclined cover plate encloses the lower sleeving portion.

5. The waterproof box for a switch outlet combo according to claim 4, wherein the lower mounting member comprises the lower sleeving portion and the pivot pins inserted therethrough, and the upper mounting member independently comprises the upper sleeving portion; or alternatively, the upper mounting member comprises the upper sleeving portion and the pivot pins inserted therethrough, and the lower mounting member independently comprises the lower sleeving portion.

6. The waterproof box for a switch outlet combo according to claim 5, wherein a side of the base shell is provided with a wire routing groove, both sides and a bottom of the wire routing groove are provided with insertion grooves, inserting plates are inserted into the insertion grooves, and the inserting plates are removable to allow external wire access when required.

7. The waterproof box for a switch outlet combo according to claim 5, wherein the pivot pins comprise a left pivot pin and a right pivot pin, an outer end of each of the left pivot pin and the right pivot pin is provided with a cap, an inner end of each of the left pivot pin and the right pivot pin is provided with an inserting end, and the inserting end is provided with a conical head and an annular groove behind the conical head; and the two ear plates are respectively located at both ends of the lower sleeving portion, the pivot pin holes and the sleeving holes of the ear plates are aligned, and the left pivot pin and the right pivot pin are inserted through the sleeving holes of the ear plates and the pivot pin holes from both sides respectively.
